(19) United States
(12) Patent Application Publication
(10) Pub. No.: US 2008/0073289 A1
(43) Pub. Date: Mar. 27, 2008

(54) CARBON PRE-TREATMENT FOR THE STABILIZATION OF PH IN WATER TREATMENT

(76) Inventors: Thomas Anthony Ryan, Cheshire (GB); Harry Sharrock, Wigan (GB)

Correspondence Address: COHEN & GRIGSBY, P.C., 11 STANWIX STREET, 15TH FLOOR, PITTSBURGH, PA, 15222, US

(21) Appl. No.: 11/534,817

(22) Filed: Sep. 25, 2006

(51) Int. Cl. C02F 1/66

(52) U.S. Cl. 210/749

(57) ABSTRACT

Treatment of un-wetted or low moisture activated carbon with a suitable quantity of carbon dioxide provides a material which, on contact with water, controls pH in treatment water. Use of this activated carbon in a water treatment system provides water having an essentially neutral pH which is immediately potable thereby eliminating the necessity to drain and dispose of any soak water. The contact pH of the treated carbon remains within the potable pH range for treatment of more than 100 bed volumes.

### FIELD OF INVENTION

The present invention relates to a method for treating water to neutralize and maintain pH in water treatment systems and, more particularly, to treatment of dry activated carbon with small predetermined quantities of carbon dioxide.

### BACKGROUND OF THE INVENTION

Activated carbon is commonly used in the water industry for the removal of a variety of contaminants. Such contaminants include, for example: chlorinated, halogenated organic compounds (such as trihalomethanes), adsorbable organic halogens (AOX), odorous materials, coloured contaminants, compounds for biological treatment systems, aromatics, pesticides, etc. Unfortunately, irrespective of the precursor source or whether the activated carbon is virginal or reactivated, activated carbon imparts an alkaline character to water upon contact. As a result, the pH of the effluent can rise to a value exceeding 9 or 10. This excursion in alkalinity, commonly referred to as a pH spike, can result in the leaching of aluminium from the activated carbon and, additionally, the leaching of manganese and other transition metals from reactivated carbon. The net effect of this increased alkalinity is that large quantities of high-pH water are wasted by the need for excessive backwashing/extraction of the carbon in order to bring the pH back to within the potable range. This remedial activity can last for several days, sometimes requiring as many as 800 bed volumes of water. Considering that water beds used in water treatment plants generally have capacities of 2 to 50 cubic meters, remediation can require a significant volume of water.

U.S. Pat. No. 5,876,607 assigned to Calgon Carbon Corporation describes a method for treating water to control pH and aluminium concentration in the water using a activated carbon (exemplified by F400) soaked with water then treated with either carbon dioxide or carbon dioxide followed by air. Such use of carbon is occasionally employed, but has not become part of common industrial practice owing to the high costs involved in draining and disposal of the initial soak water necessary to wet the carbon in preparation for carbon dioxide treatment. Additionally, the transportation burden of the water wetted carbon, and even then the continued need for a number of bed-washes to stabilize the water's pH has prevented common use of the method.

Thus, there is a need for a more effective and efficient process for treating water with activated carbon that reduces any excessive pH rise and consequent increase of metal ion concentration in water, and a process that overcomes the shortcomings of the prior art. It is also desirable to provide a satisfactory means of making efficient contact of the carbon dioxide with the activated carbon to be used for the water treatment application.

### SUMMARY OF THE INVENTION

The present invention provides an activated carbon with reduced contact pH and a method for treating water with activated carbon that reduces excessive pH rise in the water and leaching of selective metals. The method comprises first treating an activated carbon with carbon dioxide for a predetermined amount of time, and second, contacting the water to be treated with an appropriate amount of the treated activated carbon. The method using treated activated carbon can be employed in adsorption/filtration systems for the purification of water.

The starting carbon may be activated or reactivated carbon. It is to be used in the condition “as received,” which is generally dry and not purposely wetted. There is no need to purposely dry the carbon to a condition drier than as it was upon receipt from the plant in which it was produced provided it is of low moisture. The carbon should contain less than 10% moisture. In an embodiment, the carbon contains less than 2% moisture.

A sufficient amount of the dry, un-wetted activated carbon is then treated by exposing it to carbon dioxide. Exposure is conducted for an amount of time sufficient to achieve about 0.1-10% loading of carbon dioxide by weight of said carbon. In most examples, loading would be less than about 1% carbon dioxide and, preferably, about or less than about 0.5% carbon dioxide. The exposure time is calculated based upon the contact pH of the activated carbon employed and the initial pH of the water to be treated. The activated carbon is loaded with carbon dioxide, for example, by flowing a gas comprised substantially of carbon dioxide through a bed of activated carbon. Preferably the carbon is in the form of pellets, granulars or the like. Alternatively, in an example, solid carbon dioxide (dry ice) is added to activated carbon. This latter means of treatment offers the further benefits of convenience and accurate measurement. Such benefits are particularly useful for larger scale use, for example in water treatment facilities.

The treated activated carbon is then contacted with the water to be treated. Generally, about one bed volume of the treated carbon is employed. The specific amount of activated carbon depends upon the size of the filter bed.

The addition of carbon dioxide to dry, low moisture activated carbon was surprisingly found to enable effective control and maintenance of the alkalinity of treatment water to within the potable range. It is believed that carbon when treated in this way provides a beneficial buffer. The dry carbon makes efficient use of the buffer through “buffering action.”

The activated carbon generates hydroxyl ions, the concentration of which governs the extent of carbon dioxide desorption from the activated carbon, the degree of hydration to carbonic acid and the subsequent dissociation of the acid. It is contemplated that some of the carbon dioxide is desorbed from the treated carbon upon addition of water to give a partition between the adsorbed and aqueous phases:

CO₂(ads)λCO₂(aq).

The CO₂ (aq) phase is in equilibrium with carbonic acid, vis:

CO₂+H₂OλH₂CO₃

Hydroxyl ions present, or formed, on the carbon then combine with the hydrogen ions arising from the dissociation of the carbonic acid to form unionised water:

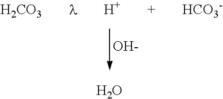

### It is believed this last equilibrium will be disturbed by the presence or generation of hydroxyl ions, and more carbonic acid will be dissociated to replace the hydrogen ions that were removed.

The inventors have discovered that by using a dry, low moisture carbon that enables a controlled partition of carbon dioxide between the adsorbed and aqueous phases, carbon dioxide can remain available to neutralize the high pH when the carbon dioxide-laden carbon is contacted with the water to be treated. Despite the general belief that carbon dioxide would not adsorb well onto carbon and would only be retained if the carbon was wetted, it was found that the carbon dioxide penetrates deep inside the pores of dry activated carbon. It was not previously realized that an aqueous phase actually blocked access to the carbon in the prior process using wetted activated carbon, as in U.S. Pat. No. 5,876,607, and thus water inhibited the access of carbon dioxide into the micropores. As a result, carbon dioxide was mostly adsorbed into the water layers and readily lost to the aqueous phase. With the carbon dioxide mainly in the aqueous phase, it would have been removed in the first stages of washing.

An advantage of the present invention resulting in part from its ability to directly adsorb carbon dioxide from the gas phase is a reduction of time and, therefore, cost. The invention may also obviate the need for excessive backwashing and the need to remove voluminous quantities of wasted water. The pH of the water being contacted with carbon dioxide-treated carbon will very quickly become within the generally accepted, potable pH range of 6.5 to 8.5. It will remain within the potable range after treatment with the carbon dioxide-laden carbon even after treatment with 100 bed volumes. Judging by the trends of the results illustrated by the curves shown in the Figures disclosed herein, the inventors contemplate that the pH would remain within the potable range thereafter. It is contemplated that water savings could be up to 800 bed volumes×as much as 50 cubic metres, or 40,000 cubic meters of water. Savings on carbon dioxide could also be appreciable.

Since metal leaching is very much a function of pH, the inventors believe that metal contamination of the water will also be controllable by this inventive process. Acidity and basicity have a profound effect on the solubility of alumina. If the water is acidic (pH<6.5) then alumina dissolves as the hexaquo ion, [Al(H₂O)₆]³⁺. If the water is alkaline (pH>8.5) the alumina dissolves as the hydroxyaluminate, [Al(OH)4]-species, as illustrated in FIG. 5. Other metals can show similar effects. Particularly, such other metals may include metal oxide or hydroxide-containing species that have an increased solubility in water of high alkalinity and that may constitute a potential contaminant to the water which they may contact. In practice, aluminium is a problem at high pH and manganese is a problem at low pH. Thus, it is contemplated that control of pH will lead to the control of metal leach.

It is an object in an embodiment of the present invention to provide a process of water treatment that reduces pH and the concentration of selective, leachable metals (such as aluminium and manganese) during the start-up phase of aqueous adsorption systems (such as initial potable fills). In an embodiment it is an object to reduce or remove pH spike and maintain the pH of the water in the potable range right from the initial contact with the carbon. Another embodiment provides a modified activated carbon effective for reducing or removing pH spike. It is still a further object in an embodiment to provide a convenient and efficient means for pre-treating carbon for larger scale water treatment facilities.

Other objects, features, aspects and advantages of the present invention will become better understood or apparent from the following detailed description, drawings, and appended claims of the invention.

### BRIEF DESCRIPTION OF THE DRAWINGS

FIG. 1 graphically illustrates the pH profile that occurs following water treatment with one untreated carbon and seven treated samples of carbon each having different weight for weight carbon dioxide loading according to examples of the present invention.

FIG. 2 graphically illustrates the initial contact pH as a function of the carbon dioxide loading on activated carbon resulting from exposure of the water to the carbon.

FIG. 3 graphically illustrates the contact pH of F400 carbon with 0.3% carbon dioxide by weight as a function of added bed volumes of water (♦ line), and compares it to the effects of untreated carbon (▪ line), wet, activated carbon, treated with carbon dioxide ( line), and un-wetted modified carbon (▾ line).

FIG. 4 graphically illustrates data for reactivated F400 carbon.

FIG. 5 shows the effect of pH on the solubility of alumina.

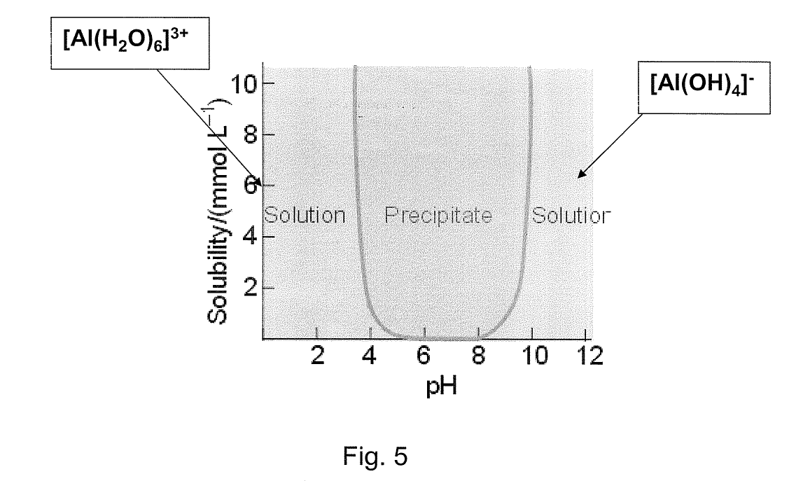

FIG. 6 graphically illustrates the effluent pH as a result of water treatment using a modified carbon according to an example of the present invention.

FIG. 7 graphically illustrates the effluent pH as a result of water treatment using a modified carbon according to another example of the present invention.

### DETAILED DESCRIPTION OF EXAMPLES OF THE INVENTION

Activated carbon (as received F400, 12×40 US mesh) was transferred to a glass container fitted with a dip pipe and exposed to a flow of various quantities of carbon dioxide to give carbon dioxide loadings varying from 0.1 to 10% by weight. For a preferred example, the loadings vary from 0.2 to 5%. The latter representing the maximum amount of carbon dioxide that can be taken tip by the carbon. Depending upon the selected carbon, it may be excessive for this application, resulting in carbons that would impart too much acidity to the water and be below the potable pH value. Appropriate loadings are determined by applying a convenient flow rate of carbon dioxide based on the weight of the gas for the required amount of time−ml/min×total minutes gives total volume. The carbon is weighed before and after the gas is flowed through and the weight uptake is confirmation of the final loading. Untreated activated carbons were used as the control, and a carbon prepared by the method of U.S. Pat. No. 5,876,607 was used for comparison. Additional work was carried out using reactivated carbon (as received F400 React, 12×40 US mesh, ex. Feluy) loaded with carbon dioxide at approximately 0.3 and 0.5% w/w, respectively, as further described below.

### EXAMPLE 1

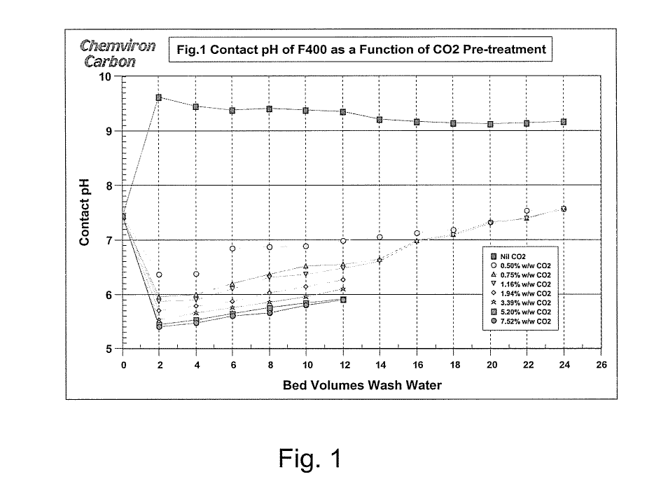

Samples of untreated carbon and carbon treated as described above in amounts of 100 cm³ were added, in turn, to two bed volumes of water locally supplied by Ashton-in-Makerfield Township with stirring. The initial pH of the local water was 7.44. The contact pH was recorded after 30 minutes. The water was then decanted and two bed volumes of fresh Township water were added. This process was repeated a number of times to represent the effect of additional bed volumes. The contact pH was plotted as a function of the number of water bed volumes. Results are shown in FIG. 1.

All experiments were conducted at the laboratory ambient temperature and pressure. The laboratory bed volume measured 200 cubic centimetres (i.e. two bed volumes stated above).

### Untreated Virgin Carbon

Addition of two bed volumes of the town's water to untreated F400 activated carbon resulted in the anticipated pH spike as illustrated in FIG. 1. The pH of the water was 7.44 but rose to 9.62 when added to untreated activated carbon. This immediate increase in pH to 9.62 was followed by a very slowly reducing level of alkalinity with increasing bed volumes of water added. After about 25 bed volumes were added, the alkalinity of the water in this system (equivalent to a pH of about 9.2) was still beyond the upper potable pH range of 6.5-8.5. This result was consistent with the findings disclosed in the U.S. Pat. No. 5,876,607 which demonstrated that return of the water to a potable condition, when using untreated F400 with the particular water supply (Robinson Township Municipal Authority tap water), did not occur until almost 200 bed volumes had been applied.

### Treated Virgin Carbon

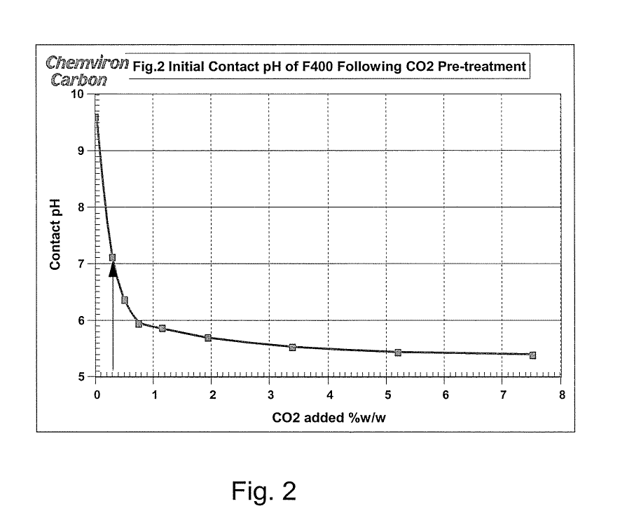

Samples of F400 activated carbon were treated with varying quantities of carbon dioxide. Each sample was contacted with two bed volumes of water from Ashton-in-Makerfield Township. The water had an initial pH of 7.44. The contacted water experienced an immediate decrease in the effluent water's pH. The degree to which the decrease occurred was noted to be a function of the amount of carbon dioxide added. For example, F400 carbon saturated with carbon dioxide (corresponding to a loading of 7.52%) gave the biggest fall, to about 5.4 pH. A loading of only 0.5% carbon dioxide gave a drop in pH to about 6.4. The influence of carbon dioxide loading on initial contact pH is illustrated in FIG. 2.

The contact pH corresponding to 0% carbon dioxide loading is that resulting from exposure of the water to untreated carbon. Knowledge of this value together with the other experimental points illustrated in FIG. 1 enables the loading of carbon dioxide (to give an initial contact pH of 7.0) to be inferred by interpolation. Hence, from the graph, a loading of 0.3% carbon dioxide should produce an initial contact pH of 7.0. In practice this loading gave a measured initial contact pH 7.12.

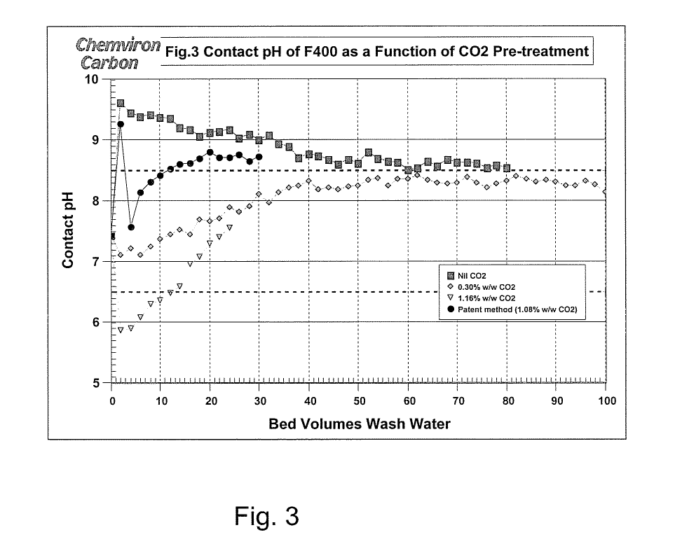

The contact pH of F400 carbon with 0.3% carbon dioxide loading is illustrated in FIG. 3 as a function of added bed volumes (♦ line). This can now be compared to the effect of untreated carbon (▪ line) requiring some 80 bed volumes before the water pH reached the top of the potable pH range, and to the effect of wet, activated carbon, treated with carbon dioxide as described in the U.S. Pat. No. 5,876,607 ( line). In that patent, the quantity of carbon dioxide applied to the wetted carbon was 1.08% (additional amounts were shown to be of no advantage). For further comparison, a similar quantity of carbon dioxide was applied to un-wetted treated carbon (V line).

According to the patented method, F400 carbon was soaked in an unspecified quantity of water for 16 hours before being drained and subsequently treated with carbon dioxide, and this procedure was followed here. Two bed volumes of soak water were added to the F400 and left for 16 hours. The drained soak water had a pH of 9.27. The wetted carbon was then treated with carbon dioxide and a further two bed volumes of water were added to give a contact pH of about 7.6. This value rose above the upper potable range of 8.5 after the subsequent addition of 12 bed volumes of water, as observed in FIG. 3.

The dry 0.3% carbon dioxide-treated carbon delivered water with a pH in the standard, potable range throughout the course of the washings. Use of 0.5% carbon dioxide-treated carbon for this carbon-water system would likely result with a water pH that would be too acidic. Increasing the dry carbon dioxide loading to 1.16%, however, produced initially acidic water which was below the pH 6.5 threshold up to about 10 bed volumes.

The ideal loading of carbon dioxide varies depending upon the selected carbon and the water to be treated. For the best results in a particular situation a suitable amount of loading should be determined up-front, especially before conducting large scale water treatment. This determination may be aided with extrapolation from related tests or graph interpolation. As exemplified above, a 7.52% loading was excessive because it gave too much of a pH drop (down to 5.4 in the last example). The appropriate amount of carbon dioxide for most situations involving carbon pre-treatment is expected to range from about 0.1 to 10% by weight of the carbon.

### Reactivated Carbon

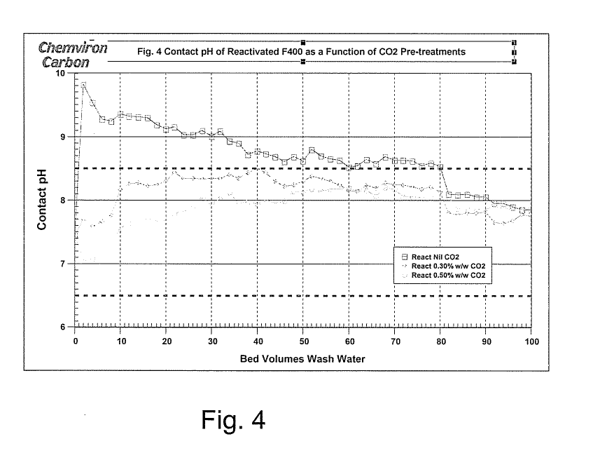

Data for reactivated F400 carbon is illustrated in FIG. 4. The n open squares represent the pH of the water as a function of the number of bed volumes for untreated material. The ⋄ and ∘ lines represent the situation after pre-treatment with 0.3 and 0.5% carbon dioxide, respectively.

It is notable that the untreated, reactivated carbon required about 80 bed volumes to bring the water pH into the potable range whereas both the carbon dioxide-treated carbons are consistently and immediately within the potable range.

### EXAMPLE 2

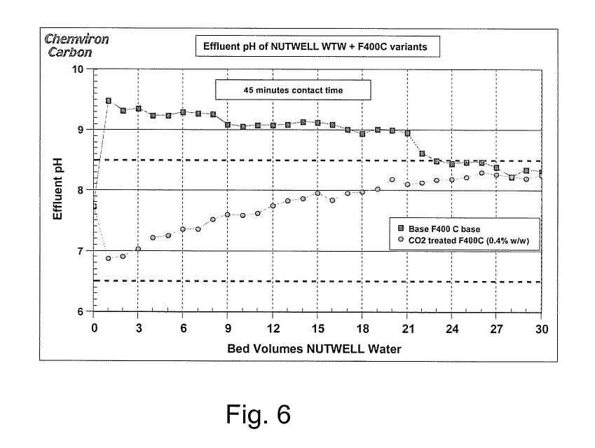

Activated carbon (as received F400 carbon) was treated by exposing it to a flow of carbon dioxide gas to give a loading of 0.4% weight carbon dioxide by weight of the carbon. A loading of 0.4% carbon dioxide was pre-selected based on anticipated condition similarities with the prior example. A sample of treated carbon was used to contact raw feed waters from Nutwell Water Treatment Works (Yorkshire Water). For comparison, a sample of untreated carbon was also contacted with the feed water. Each sample contacted water contained in a laboratory bed column measuring 200 cubic centimetres. A notional contact time of 45 minutes was used. The pH of each treated effluent was measured at one bed-volume intervals over 30 bed volumes. Results of the two samples show a comparison of the effluent pH property of F400 carbon both with and without CO₂ pre-treatment as illustrated in FIG. 6.

### EXAMPLE 3

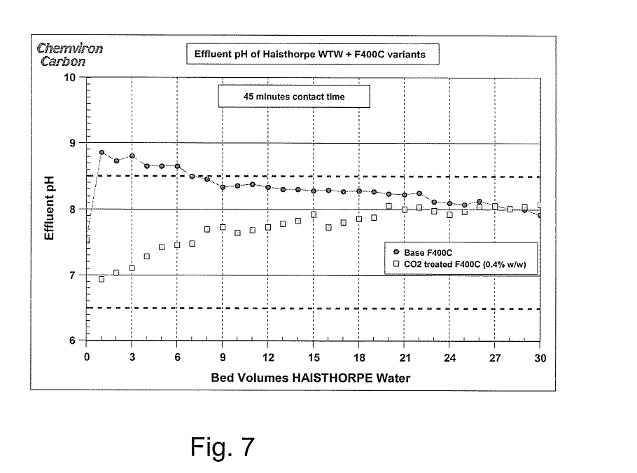

Additional samples of untreated carbon and carbon treated as described in Example 2, and contacted with water from the Haisthorpe Water Treatment Works (Yorkshire water). Results of water treatment with the carbon samples are illustrated in FIG. 7.

Neither of the Nutwell or Haisthorpe waters tested appeared to be particularly troublesome, indicating that only a minimal number of washes would be required during commissioning to bring the pH of the water to within the potable range. Nevertheless, treatment of the Filtrasorb 400 carbon with 0.4% w/w carbon dioxide gas produced effective nullification of the initial pH spike for both water samples, which were immediately measured to be within the potable limits, indicated by the dotted lines in FIGS. 6 and 7.

While the foregoing has been set forth in considerable detail, it is to be understood that the detailed embodiments and Figures are presented for elucidation and not limitation. Process variations may be made, but remain within the principles of the invention. Those skilled in the art will realize that such variations, modifications, or changes therein are still within the scope of the invention as defined in the appended claims.

What is claimed is:

1. A method for treating water to control excessive pH in the treated water, said method comprising:
a. preparing a bed of low moisture activated carbon,
b. loading said activated carbon with carbon dioxide to about 0.1 to 1% by weight of said carbon, and
c. contacting said water with said loaded carbon dioxide for an appropriate amount of time.

2. A method for treating water as set forth in claim 1 comprising the further step (d) of providing water with a pH in the potable range of about 6.5 to 8.5.

3. A method for treating water as set forth in claim 1 wherein said carbon dioxide is in the form of a gas or solid.

4. A method for treating water as set forth in claim 1 wherein the carbon of step (a) contains less than 10% moisture.

5. A method for treating water as set forth in claim 1 wherein the carbon of step (a) is un-wetted.

6. A method for treating water as set forth in claim 1 wherein said contacting in step (c) is conducted for an appropriate amount of time to minimize metal leaching from contaminants in said water.

7. A method for treating water as set forth in claim 7 wherein said contaminants comprise any metal oxide or hydroxide-containing species having an increased solubility in water of high alkalinity.

8. An activated carbon for treating water to control pH in the treated water, said carbon comprising a low moisture activated carbon containing carbon dioxide in the amount of about 0.1 to 10% by weight of said carbon.

9. An activated carbon as set forth in claim 9 wherein the carbon contains less than 10% moisture.

10. An activated carbon as set forth in claim 9 wherein said carbon dioxide is evenly distributed on said carbon.

11. An activated carbon as set forth in claim 9 wherein said carbon dioxide is in the amount of about 0.1 to 0.8% by weight of said carbon.
